(19) United States
(12) Patent Application Publication
(10) Pub. No.: US 2014/0368497 A1
(43) Pub. Date: Dec. 18, 2014

(54) Angular Display for the Three-Dimensional Representation of a Scenario

(71) Applicants: Leonhard Vogelmeier, Dachau (DE); David Wittmann, Muenchen (DE)

(72) Inventors: Leonhard Vogelmeier, Dachau (DE); David Wittmann, Muenchen (DE)

(73) Assignee: EADS Deutschland GmbH, Ottobrunn (DE)

(21) Appl. No.: 14/343,523

(22) PCT Filed: Sep. 5, 2012
(86) PCT No.: PCT/DE2012/000885

§ 371 Date: May 23, 2014

(30) Foreign Application Priority Data
Sep. 8, 2011 (DE) 10 2011 112 620.5

(51) Int. Cl. G06T 15/20

(52) U.S. Cl. CPC G06T 15/20
USPC 345/419

(57) ABSTRACT

A representation device has a first representation region and a second representation region for representing a three-dimensional scenario. The first representation region is disposed in a first plane and the second representation region is disposed in a second plane, the first plane and the second plane forming an included angle α relative to one another. The angled position reduces conflict between convergence and accommodation in the human visual apparatus, supporting low-fatigue viewing of a three-dimensional scenario.

### FIELD OF THE INVENTION

Exemplary embodiments of the invention relate to a representation device for representing a three-dimensional virtual scenario, a workstation device for representing a three-dimensional virtual scenario, the use of a workstation device for representing a three-dimensional virtual scenario, for representing and monitoring air spaces, and the use of a workstation device for representing a three-dimensional virtual scenario as an air traffic control workstation.

### BACKGROUND OF THE INVENTION

Stereoscopic visualization techniques are used to create the impression of a three-dimensional scenario in a viewer of a stereoscopic display. The viewer experiences the three-dimensional impression in that the viewer's eyes perceive different images. This may be attained, for example, by projecting two different images towards the viewer such that each eye perceives only one of the two images. This may furthermore be attained by the viewer wearing eyeglasses with polarized lenses and differently polarized images are displayed on a display and the polarization of the images and of the eyeglasses are matched to one another such that each of the viewer's eyes perceives only one image.

U.S. Pat. No. 6,412,949 B1 discloses a representation device based on the stereoscopic principle and uses polarization filters.

### SUMMARY OF THE INVENTION

Exemplary embodiments of the invention provide a representation device for representing a three-dimensional virtual scenario that permits improved representation of the three-dimensional virtual scenario.

In accordance with a first aspect of the invention, a representation device for representing a three-dimensional virtual scenario includes a first representation region and a second representation region for representing the three-dimensional scenario. The first representation region is disposed in a first plane and the second representation region is disposed in a second plane, the first plane and the second plane forming an included angle α relative to one another.

The first representation region and the second representation region may be a display element designed for stereoscopic visualization. The representation region may thus be a display or a projection surface suitable for being used for a stereoscopic visualization technique.

In particular the first representation region and the second representation region may be arranged such that two planes, in each of which a representation region is disposed, have an included angle relative to one another.

The included angle is preferably not equal to zero degrees. However, the included angle may in fact be 0°, i.e., the first plane and the second plane are parallel to one another and preferably do not overlap one another, i.e. the first plane and the second plane are offset to one another in the direction of a line that is perpendicular to one of the planes.

If the planes are described as being disposed parallel to one another, this means that the planes do not have any common point of intersection or line of intersection.

The first representation region and the second representation region may, however, also be arranged relative to one another such that the first plane and the second plane, which include the first representation region and the second representation region, respectively, intersect one another such that they form a line of intersection.

The angle at which the first plane and the second plane intersect one another is the included angle α.

The first representation region and the second representation region may be arranged such that they are coupled to one another at the line of intersection for the first and second planes. Naturally the first representation region and the second representation region may also be arranged such that they are not coupled to one another.

The inventive structure of a representation device for a three-dimensional scenario permits lengthier concentrated viewing of a virtual three-dimensional scenario since the structure of the representation device can support low-fatigue viewing of a three-dimensional virtual scene that preserves the viewer's visual apparatus.

During the representation of spatial information by means of stereoscopic visualization techniques, as a rule the coupling of convergence (movement of the axes of a viewer's eyes towards one another) and accommodation (adjustment in the refractive power of the lens) must be suspended.

During vision, the axes of the eyes are positioned relative to one another such that both eyes look directly at a viewed object. The position of the axes of the eyes relative to one another changes depending on the distance between a viewer and the viewed object, since human eyes are spaced apart from one another laterally. Convergence is more pronounced the smaller the distance is between the eyes and a viewed object. When a viewed object is at a very close distance from the eyes of a viewer, i.e. distances of a few centimeters, for instance three to five centimeters, convergence is extremely pronounced and viewing such an extremely close object leads to the viewer experiencing strabismus.

In addition to the effect on the position of the axes of the eyes relative to one another, i.e., the effect on convergence, the distance to a viewed object also has an effect on the adjustment of the refractive power of the lens of the eye, i.e., accommodation.

In natural vision, convergence and accommodation are normally coupled to one another such that conflicting information, such as e.g. extremely pronounced convergence and minor accommodation, can cause a viewer of an object to experience fatigue of his visual apparatus, nausea, and headaches. The conflicting information is caused because convergence indicates a close distance to the viewed object and accommodation indicates precisely the opposite—a great distance to the viewed object.

A conflict between convergence and accommodation may especially occur when viewing three-dimensional virtual scenes. This is because the convergence derives from the virtual location of the virtual object and, in contrast, the accommodation derives from the distance to the imaging surface.

It is entirely understandable that in stereoscopic visualization techniques that generate a virtual three-dimensional scenario the virtual location of a virtual object is only rarely congruent with the actual location of the imaging surface.

A representation device having a first representation region and a second representation region, which regions are arranged at an angle to one another, may reduce the conflict between convergence and accommodation when a three-dimensional virtual scenario is being viewed, since an imaging surface, i.e. the first representation region or the second representation region, from the point of view of a viewer viewing the virtual scenario, has a shorter distance to a viewed virtual object.

The representation device may of course have more than two representation regions, for instance three, four, five, or an even greater number of representation regions.

In accordance with one embodiment of the invention, the first representation region and the second representation region are flat. This means that the imaging surface or the visualization surface of the representation regions is embodied in the shape of a plane.

However, the representation regions may also be embodied in the shape of a circular arc or in the shape of a hollow cylinder arc, the three-dimensional equivalent of the circular arc. Likewise, the representation regions may be embodied as hollow hemispheres, the imaging surface being arranged on a surface of the representation region that is oriented towards a center point of the hollow cylinder arc or hemisphere.

If the representation regions are not embodied in the shape of a plane, the first plane and the second plane each represent a tangential plane of the representation regions. In particular, if the representation regions are not embodied in the shape of a plane, each representation region may have a plurality of tangential planes. For instance, each image line of the imaging surface of a representation region may have a tangential plane.

Representation regions embodied as circular arcs may then be arranged relative to one another such that a first tangential plane of the first representation region and a second tangential plane of the second representation region have an included angle α relative to one another.

In accordance with another embodiment of the invention, the included angle α is between 90° and 150°

Thus the first representation region and the second representation region, which has the included angle α relative to the first representation region, and the eye position of the viewer cover a representation space. The representation space is the space in which the virtual three-dimensional scenario is represented, i.e. in which a virtual location of the virtual objects may be represented in the three-dimensional scenario.

Naturally the three-dimensional virtual scenario may also be represented such that the virtual objects are disposed out of the viewer's sight behind the visualization surface of the representation region.

In accordance with another embodiment of the invention, the included angle α that the first representation region and the second representation region form relative to one another is 120°.

In accordance with another embodiment of the invention, the representation device has a rounded transition in an angular region between the first representation region and the second representation region.

If the first representation region and the second representation region are coupled to one another, this may lead to there being, between the representation regions, an edge that is actually present and is also visible and represents an interference factor when the three-dimensional virtual scenario is being viewed.

A rounded transition between the first representation region and the second representation region prevents an edge from being visible and may therefore improve the three-dimensional impression of the virtual scene for the viewer.

In accordance with another embodiment of the invention, the representation device is designed to represent the three-dimensional virtual scenario using stereoscopic visualization techniques.

In addition, special projection techniques may also be used that are suitable for creating a three-dimensional impression of a virtual scene in a viewer. In particular, any visualization technique that uses an imaging surface or a visualization surface may be used for creating a three-dimensional impression in a viewer.

In accordance with another aspect of the invention, a workstation device for representing a three-dimensional virtual scenario having a representation device for a three-dimensional virtual scenario is provided as described above and in the following.

The workstation device may for instance also be used by one or a plurality of users to monitor any scenarios.

The workstation device as described in the foregoing and in the following may of course have a plurality of representation devices, but may also have one or a plurality of conventional displays for representing additional two-dimensional information.

Moreover, the workstation device may have input elements that may be used for interacting with the three-dimensional virtual scenario.

The workstation device may have a so-called computer mouse, a keyboard, or use-typical interaction devices, for instance those for an air traffic control workstation.

Likewise, all of the displays may be conventional displays or touch-sensitive displays (so-called touchscreens).

In accordance with another aspect of the invention, a workstation device as described in the foregoing and in the following is provided for representing and monitoring air spaces.

In accordance with another aspect of the invention, a workstation device as described in the foregoing and in the following is provided for use as an air traffic control workstation.

The duties of an air traffic controller can demand intense concentration for an extended period of time. The workstation device as described in the foregoing and in the following may offer a manner of representing the air space three-dimensionally that permits a natural reproduction of the air space and protects the viewer of the virtual scene from experiencing fatigue of his visual apparatus even given extended activity.

Thus the workstation device may in particular improve the productivity of an air traffic controller when he is monitoring the air space assigned to him. Naturally the workstation device may also be used for other purposes, for instance for monitoring and controlling unmanned aircraft.

Likewise, the workstation device may also be used for controlling components such as for instance a camera or other sensors that are components of an unmanned aircraft.

Exemplary embodiments of the invention shall be described in the following with reference to the figures.

### BRIEF DESCRIPTION OF THE FIGURES

FIG. 1 depicts a representation device in accordance with one exemplary embodiment of the invention.

FIG. 2 depicts a representation device in accordance with another exemplary embodiment of the invention.

FIG. 3 depicts a representation device in accordance with another exemplary embodiment of the invention.

FIG. 4 depicts a side elevation of a workstation in accordance with one exemplary embodiment of the invention.

FIG. 5 depicts a side elevation of a workstation in accordance with another exemplary embodiment of the invention.

### DETAILED DESCRIPTION OF EXEMPLARY EMBODIMENTS

In the following description of the figures, identical reference numbers refer to identical or similar elements. The figures are diagrammatic and not to scale.

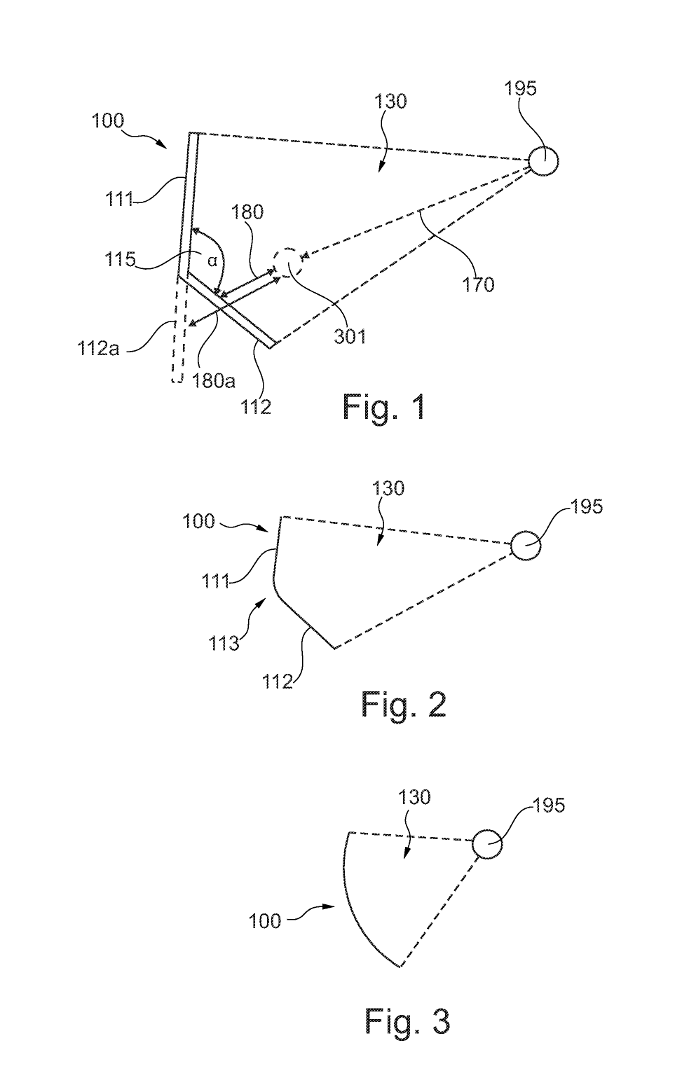

FIG. 1 depicts a representation device 100 having a first representation region 111 and a second representation region 112.

The first representation region and the second representation region are arranged such that they have an included angle α 115 relative to one another. Thus, the first representation region, the second representation region, and an eye position 195 of a viewer of the representation device cover a representation space 130 in which a virtual three-dimensional scene with virtual objects 301 is represented.

The conflict between convergence and accommodation in a viewer of a three-dimensional virtual scenario in the representation space 130 may be significantly reduced by arranging the first representation region and the second representation region at an angle to one another.

Convergence results from the distance between the eyes 195 of a viewer and the virtual location of the viewed virtual object 301 along a viewing direction 170 of the viewer. In contrast, accommodation results from the distance between the imaging surface, which in FIG. 1 is the second representation region 112, and the eye 195 of a viewer in the viewing direction 170.

Naturally the virtual representation of a three-dimensional scenario leads to a conflict between convergence and accommodation, because the virtual three-dimensional scenario includes depth information, but this depth information is not truly present since the imaging surface of a representation region is purely two-dimensional.

The included angle α 115, in which the first representation region and the second representation region are arranged relative to one another, may lead to the conflict between convergence and accommodation being diminished in that a first distance 180 between the virtual location of the virtual object 301 and the imaging surface of a representation region is reduced due to the angled position of the representation regions relative to one another.

In addition to the angled second representation region 112, FIG. 1 depicts a hypothetical representation region 112a, indicated with broken lines, that does not have an included angle relative to the first representation region 111. In other words, the first representation region 111 and the hypothetical representation region 112a are disposed in the same plane.

As may clearly be seen from FIG. 1, a second distance 180a between a virtual object 301 and the hypothetical representation region 112a is clearly greater than a first distance 180 between the virtual object 301 and the second representation region 112 that is angled to the first representation region.

The first distance 180 that is between the virtual object 301 and the imaging surface and that is clearly shorter compared to the second distance 180a may lead to less conflict between convergence and accommodation when a viewer views the three-dimensional scenario and may thus permit lengthier concentrated viewing of the three-dimensional scene, being less harsh on the viewer's visual apparatus than a representation device with representation regions that are not angled with respect to one another.

FIG. 2 depicts a representation device 100 having a first representation region 111 and a second representation region 112, the representation regions having a rounded transition in an angled region 113.

The angled region 113 represents the region in which the first representation region and the second representation region are coupled to one another.

The rounded transition between the first representation region and the second representation region can prevent an actually visible edge between the representation regions from negatively influencing the three-dimensional impression of the virtual scenario.

In order to obtain a three-dimensional impression of the virtual scene, an impression that is as interference-free as possible and less irritating to a viewer's eyes, where possible actually visible objects should be removed from the representation space 130.

Just an edge between the first representation region and the second representation region may have a negative effect on the coupling of convergence and accommodation for the viewer of the virtual scene because the distance between the actual location of the visible edge and the virtual location of a virtual object causes a conflict in the viewer's visual apparatus.

FIG. 3 depicts a representation device 100 that is embodied in a circular arc shape.

The first representation region and the second representation region merge seamlessly into one another. The imaging surface of the representation device 100 in FIG. 3 embodied in a circular arc shape also reduces a conflict between convergence and accommodation in a user's visual apparatus in that a virtual location of a virtual object in the representation space 130 from the point of view of a viewer 195 has a smallest possible distance from the imaging surface of the representation device.

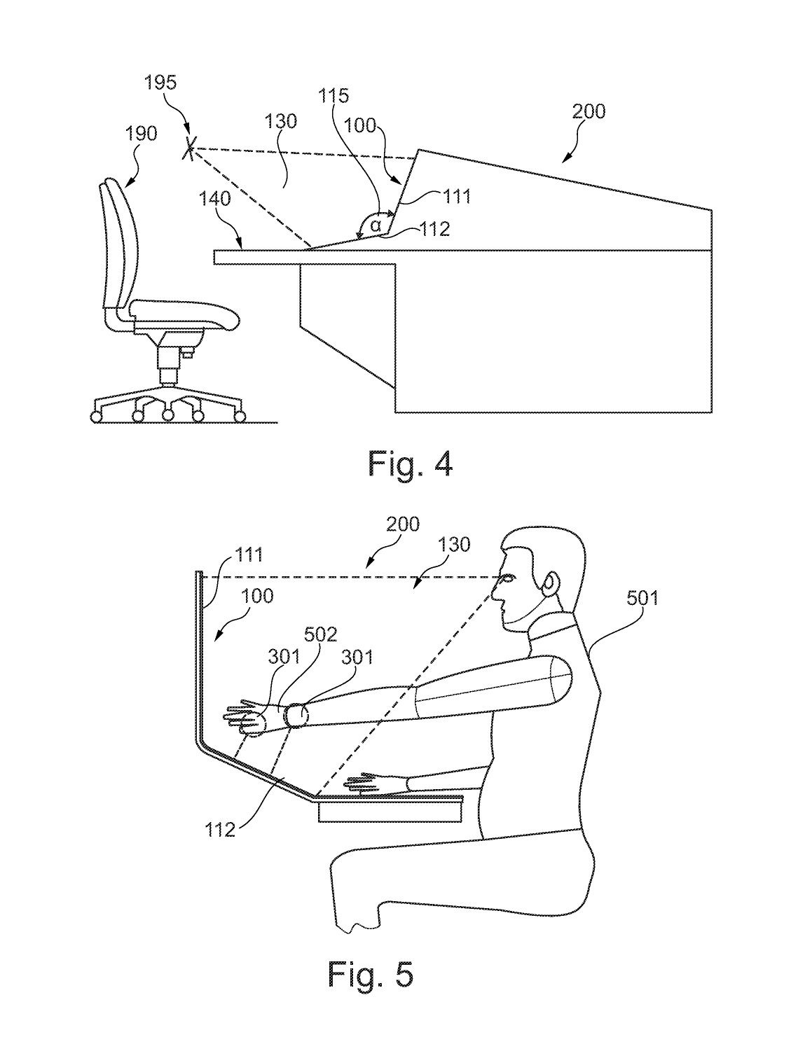

FIG. 4 depicts a workstation device 200 for a viewer or operator of a three-dimensional virtual scenario.

The workstation device 200 has a representation device 100 having a first representation region 111 and a second representation region 112, wherein the second representation region is angled, relative to the first representation region, towards the user such that the two representation regions form an included angle α 115.

With their angled position relative to a viewer position 195, i.e. the eye position of the viewer, the first representation region 111 and the second representation region 112 cover a representation space 130 for the three-dimensional virtual scenario.

The representation space 130 is thus the spatial volume in which the visible three-dimensional virtual scene is represented.

An operator who uses the seat 190 while using the workstation 200, in addition to the representation space 130 for the three-dimensional virtual scenario, can also use a workstation region 140 on which additional touch-sensitive or conventional displays may be disposed.

The included angle α 115 may be dimensioned such that all virtual objects in the representation space 130 are disposed within arm's reach of the user of the workstation device 200. There is good adaptation to the arm's reach of the user in particular with an included angle α that is between 90 degrees and 150 degrees. The included angle α may for instance also be adapted to the individual requirements of an individual user and may thus fall below or exceed the range of 90 degrees to 150 degrees. In one exemplary embodiment, the included angle α is 120 degrees.

The greatest possible overlaying of the arm's reach or of the reaching distance of the operator with the representation space 130 supports intuitive, low-fatigue, and ergonomic viewing of the virtual scene and operation of the workstation device 200.

In particular the angled geometry of the representation device 100 is able to reduce the conflict between convergence and accommodation during the use of stereoscopic visualization techniques.

The angled geometry of the representation region may minimize the conflict between convergence and accommodation in a viewer of virtual three-dimensional scene in that, due to the angled geometry, the virtual objects are positioned as close as possible to the imaging representation region.

Since the position of the virtual objects and the geometry of the virtual scenario overall is the result of each special application, the geometry of the representation device, for instance the included angle α, may be adapted to the specific application.

For monitoring air space, the three-dimensional virtual scenario may be depicted for instance such that the second representation region 112 is the virtually displayed surface of the earth or a reference surface in the space.

Thus the inventive workstation device is suitable in particular for lengthier, low-fatigue viewing and processing of three-dimensional virtual scenarios with integrated spatial representation of geographically referenced data such as e.g. aircraft, waypoints, control zones, threat spaces, terrain topographies and weather events, with simple intuitive interaction options and simultaneous representation of an overview region and a detail region.

The workstation device as described in the foregoing and in the following thus permits a large stereoscopic representation volume or representation region. Furthermore, the workstation device permits a virtual reference surface to be positioned in the virtual three-dimensional scenario, for instance a terrain surface, in the same plane as the representation region actually present.

Thus, a distance between the virtual objects and the surface of the representation regions may be reduced and therefore it is possible to reduce a conflict between convergence and accommodation in the viewer. Moreover, this reduces interfering influences on the three-dimensional impression, which influences are caused when the user extends a hand into the representation space and thus the eye of the viewer simultaneously perceives an actual object, i.e., the hand of the user, and virtual objects.

FIG. 5 depicts a workstation device 200 having a representation device 100 and depicts a person 501 viewing the represented three-dimensional virtual scenario. The representation device 100 has a first representation region 111 and a second representation region 112 that, together with the eyes of the viewer 501, cover the representation space 130 in which the virtual objects 301 of the three-dimensional virtual scenario are disposed.

A distance between the user 501 of the representation device 100 may be dimensioned such that it is possible for the user to reach the majority or the entire representation space 130 with at least one of his arms. Thus the viewer is given the ability to interact with the objects in the virtual scenario.

The representation device as described in the foregoing and in the following may naturally also be embodied to represent virtual objects whose virtual location from the point of view of the user is disposed behind the visualization surface of the representation unit. In this case, however, no direct interaction is possible between the user and the virtual objects, since the user cannot reach through the representation unit.

The actual position of the user's hand 502, the actual position of the representation device 100, and the virtual position of the virtual objects 301 in the virtual three-dimensional scenario may thus differ from one another as little as possible so that conflict between convergence and accommodation may be reduced to a minimum in the visual apparatus of the user.

The structure of the workstation device may support lengthier concentrated use of the workstation device as it is described in the foregoing and in the following in that the user experiences reduced side effects of a conflict between convergence and accommodation, such as for instance headaches and nausea.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A representation device for representing a three-dimensional virtual scenario, the representation device comprising:
a first representation region; and
a second representation region, wherein the first and second representation regions are configured to represent the three-dimensional scenario,
wherein the first representation region is disposed in a first plane and the second representation region is disposed in a second plane;
wherein the first plane and the second plane form an included angle relative to one another.

12. The representation device of claim 11, wherein the first and second representation regions are flat.

13. The representation device of claim 11, wherein the included angle is between 90° and 150°.

14. The representation device of claim 11, wherein the included angle is 120°.

15. The representation device of claim 11, wherein the representation device has a rounded transition in an angled region between the first representation region and the second representation region.

16. The representation device of claim 11, wherein the representation device is configured to represent the three-dimensional virtual scenario using stereoscopic visualization techniques.

17. A workstation device for representing a three-dimensional virtual scenario, the workstation device comprising:
a representation device comprising
a first representation region; and
a second representation region, wherein the first and second representation regions are configured to represent the three-dimensional scenario,
wherein the first representation region is disposed in a first plane and the second representation region is disposed in a second plane;
wherein the first plane and the second plane form an included angle relative to one another.

18. The workstation device of claim 17, wherein the workstation device is configured to represent and monitor air spaces.

19. The workstation device of claim 17, wherein the workstation device is an air traffic control workstation.

20. The workstation device of claim 17, wherein the workstation device is configured to monitor and control unmanned aircraft.
